(19) United States
(12) Patent Application Publication
(10) Pub. No.: US 2022/0082411 A1
(43) Pub. Date: Mar. 17, 2022

(54) SCALE

(71) Applicant: MITUTOYO CORPORATION, Kawasaki (JP)

(72) Inventor: Toshihiko Aoki, Kawasaki (JP)

(21) Appl. No.: 17/395,805

(22) Filed: Aug. 6, 2021

(30) Foreign Application Priority Data
Sep. 14, 2020 (JP) 2020-153548

(51) Int. Cl. G01D 5/20

(52) U.S. Cl. CPC G01D 5/202

(57) ABSTRACT

A scale includes a substrate, a scale pattern that has conductivity and is provided on a first main face of the substrate, and a conductive film that is provided on a second main face of the substrate, a base material of the conductive film being a resin material, a conductive material being added to the base material.

### CROSS-REFERENCE TO RELATED APPLICATION

This application is based upon and claims the benefit of priority of the prior Japanese Patent Application No. 2020-153548 filed on Sep. 14, 2020, the entire contents of which are incorporated herein by reference.

### FIELD

A certain aspect of embodiments described herein relates to a scale.

### BACKGROUND

There is disclosed a scale used for an electromagnetic induction type encoder (for example, see Japanese Patent Application Publication No. 2004-294225).

### SUMMARY

In the scale, a face (reverse face) where no scale pattern is formed is supported by a support member in order to relatively move along a measurement axis. Inhomogeneous distribution appears in an eddy current generated in the support member, in accordance with a position supported by the support member.

Accordingly, it is thought that a plated layer having a large thickness is formed on the reverse face of the scale, and an eddy current is generated in the plated layer. However, warp may occur in the scale in accordance with stress of the plated layer.

In one aspect of the present invention, it is an object to provide a scale that is capable of suppressing warp and suppressing inhomogeneous distribution of an eddy current.

According to an aspect of the present invention, there is provided a scale including: a substrate; a scale pattern that has conductivity and is provided on a first main face of the substrate; and a conductive film that is provided on a second main face of the substrate, a base material of the conductive film being a resin material, a conductive material being added to the base material.

### BRIEF DESCRIPTION OF DRAWINGS

FIG. 1 illustrates a structure of an electromagnetic induction type encoder using electromagnetic coupling between a detection head and a scale;

FIG. 2 illustrates a structure in which a scale is supported by a support member; and

FIG. 3 schematically illustrates a cross sectional view of a scale.

### DESCRIPTION OF EMBODIMENTS

The following is a description of embodiments, with reference to the accompanying drawings.

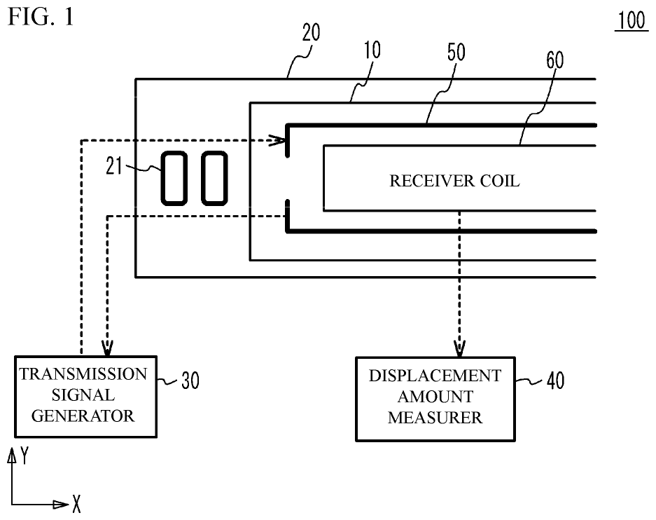

FIG. 1 illustrates a structure of an electromagnetic induction type encoder 100 using electromagnetic coupling between a detection head and a scale. As illustrated in FIG. 1, the electromagnetic induction type encoder 100 has a detection head 10 and a scale 20. The detection head 10 relatively moves in a measurement axis direction with respect to the scale 20. The detection head 10 and the scale 20 have a flat plate shape and face with each other through a predetermined gap. The electromagnetic induction type encoder 100 has a transmission signal generator 30 and a displacement amount measurer 40 and so on. In FIG. 1, an X-axis indicates a displacement direction of the detection head 10 (measurement axis). AY-axis is vertical to the X-axis in a plane formed by the scale 20.

The detection head 10 has a transceiver coil 50, a receiver coil 60 and so on. The transceiver coil 50 is a rectangular coil of which a longitudinal direction is the X-axis. As illustrated in FIG. 1, the receiver coil 60 is inside of the transceiver coil 50.

In the scale 20, a plurality of scale patterns 22 having a rectangular shape are arrayed in the fundamental period λ along the X-axis. The scale patterns 22 is electromagnetically coupled with the transceiver coil 50 and is also electromagnetically coupled with the receiver coil 60.

The transmission signal generator 30 generates a transmission signal of a single phase AC and supplies the generated transmission signal to the transceiver coil 50. In this case, magnetic flux is generated in the transceiver coil 50. Thus, an electromotive current is generated in the plurality of scale patterns 22. The plurality of scale patterns 22 are electromagnetically coupled with the magnetic flux generated by the transceiver coil 50 and generate magnetic flux fluctuating in the X-axis direction in a predetermined spatial period. The magnetic flux generated by the scale patterns 22 generates an electromotive current in the receiver coil 60. The electromagnetic coupling among each coil fluctuates in accordance with the displacement amount of the detection head 10. Thereby, a sine wave signal of the same period as the fundamental period λ is obtained. Therefore, the receiver coil 60 detects a phase of the magnetic flux generated by the plurality of scale patterns 22. The displacement amount measurer 40 can use the sine wave signal as a digital amount of a minimum resolution by electrically interpolating the sine wave signal. Thereby, the displacement amount measurer 40 measures the displacement amount of the detection head 10.

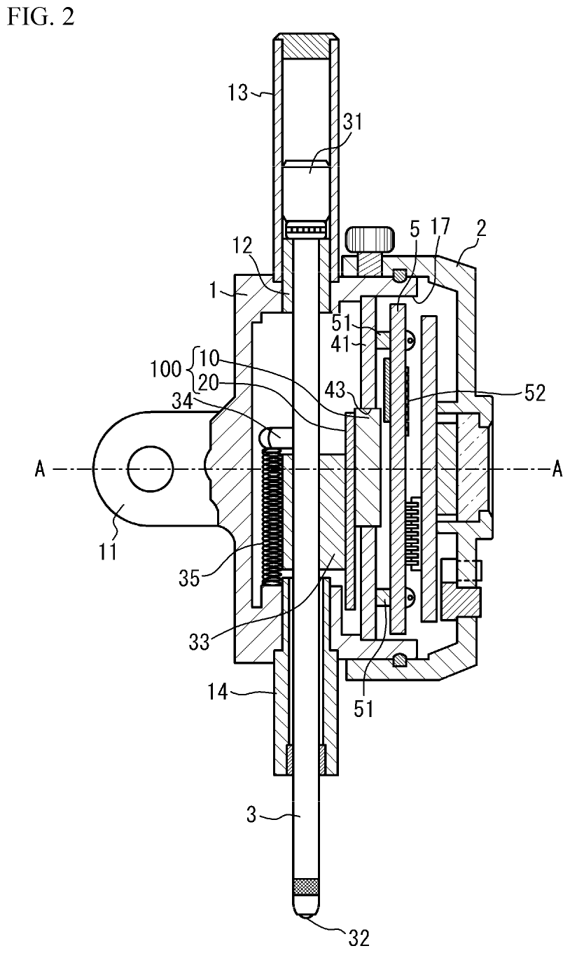

The scale 20 is supported by a support member so that the scale 20 can relatively move along the measurement axis. A face (a reverse face) of the scale 20 where the scale pattern is not provided is supported by the support member. FIG. 2 illustrates a structure in which the scale 20 is supported by the support member. As an example, FIG. 2 illustrates a cross sectional view of an indicator in which the electromagnetic induction type encoder is built.

As illustrated in FIG. 2, the indicator includes a main body case 1, a frame 2, a spindle 3 and the electromagnetic induction type encoder 100. A first end of the main body case 1 is opened. The main body case 1 has a cylindrical shape. The frame 2 is mounted on the first end of the main body case 1 and can rotate in the first end. The spindle 3 is supported by the main body case 1 and can move along the axis direction of the spindle 3. The electromagnetic induction type encoder 100 detects a displacement amount of the spindle 3 in the axis direction.

A support ring 11 is integrally formed with a center portion of the main body case 1 at a second end of the main body case 1. A spindle protective cylinder 13 is provided on an upper outer circumference of the main body case 1 through a connection member 12. The upper outer circumference is located on an upper side in FIG. 2. A stem 14 is provided on a lower outer circumference of the main body case 1.

The lower outer circumference is located on a lower side in FIG. 2. The spindle protective cylinder 13 and the stem 14 are on the same axis. The connection member 12 and the stem 14 form a bearing.

The spindle 3 is inserted in the stem 14. The spindle 3 can slide in the stem 14. A head 31 on an upper side in FIG. 2 is engaged in the spindle protective cylinder 13 and can slide in the spindle protective cylinder 13. A gauge head 32 is provided on a lower edge of the spindle 3. The lower edge projects from a lower end of the stem 14. A support member 33 and a pin 34 engaged with a spring are provided at a center portion of the spindle 3. The support member 33 and the pin 34 are inside of the main body case 1. A tension spring 35 is provided between the pin 34 and an inner wall of the main body case 1. The spindle 3 is biased toward a lower side in FIG. 2 by the tension spring 35. The tension spring 35 prohibits the rotation of the spindle 3. The tension spring 35 is extended so that a length of the tension spring 35 is longer than an equilibrium length of the tension spring 35.

A board-shaped holding member 41 is fixed with a screw to an inner wall 17 which is located on the first end of the main body case 1 which is opened. A cutout portion 43 for holding the detection head 10 described later is formed in the holding member 41, as illustrated in FIG. 2.

The electromagnetic induction type encoder 100 has the detection head 10 and the scale 20. The electromagnetic induction type encoder 100 is capable of detecting an absolute displacement amount of the spindle 3 in the axis direction. The detection head 10 is provided along the axis direction of the spindle 3 near the spindle 3. The detection head 10 is engaged with the cutout portion 43 of the holding member 41 fixed to the main body case 1. The scale 20 faces the detection head 10 in a predetermined interval. The scale 20 is fixed to the spindle 3 through the support member 33.

A substrate 5 on a side of detection is fixed on a front side of the holding member 41 (right side in FIG. 2) through a spacer 51. The substrate 5 is in parallel with the holding member 41. The substrate 5 has a circular shape along a virtual circle locus of which a center is an axis line A of the frame 2 with which the frame 2 can rotate. A contact point pattern 52 is formed on a front side (right side in FIG. 2) surface of the substrate 5.

Distribution (positional inhomogeneous distribution) may occur in the eddy current in the support member 33 because of the magnetic flux having permeated through the scale 20, in accordance with the material of the support member 33 or a support range of the scale 20 supported by the support member 33. Therefore, inhomogeneous distribution may occur in the signal intensity from the scale 20 in accordance with the location of the scale 20. When the distribution occurs in the signal intensity (positional inhomogeneous distribution), an error may occur in the measurement accuracy of the electromagnetic induction type encoder 100.

Accordingly, it is thought that a Cu-plated layer having a large thickness such as 18 μm is formed on a whole of the reverse face of the substrate of the scale 20, an eddy current is generated in the cu-plated layer, and the influence of the support member 33 is reduced. However, when the Cu-plated layer having the large thickness is provided on the reverse face of the substrate, the cost may increase. Warp may occur in the scale 20 because of the stress of the Cu-plated layer having the large thickness. A process for forming the Cu-plated layer is separately performed from a process for bonding the scale 20 to the support member 33. Therefore, the cost may increase. It is possible to suppress the warp of the scale 20 by dividing the Cu-plated layer from a continuous layer into a mesh-shaped layer. However, the magnetic flux is leaked from a gap generated by the dividing. Therefore, distribution of signal intensity may occur.

Accordingly, the scale 20 of the embodiment has a structure for suppressing warp with a low cost. A description will be given of details of the scale 20.

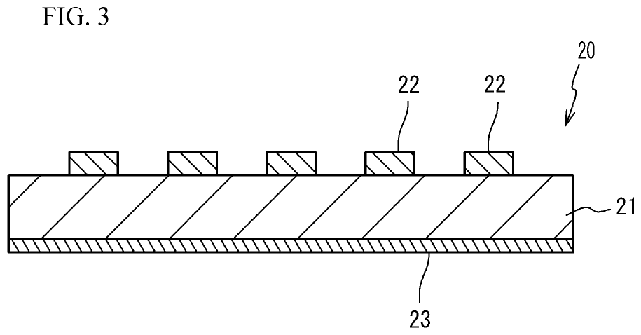

FIG. 3 illustrates a schematic cross sectional view of the scale 20. As illustrated in FIG. 3, the scale 20 has a structure in which the scale pattern 22 is formed on an upper face of a substrate 21. The scale pattern 22 has a structure in which a plurality of metal gratings are arrayed in a predetermined interval.

The substrate 21 is not limited. For example, the substrate 21 is made of a material other than a metal. For example, the material is such as a metal oxide material, an organic material, a glass epoxy material, a glass material or the like. A low expansion coefficient material such as a quartz glass (molten synthetic quartz) may be used as the glass material.

The scale pattern 22 is made of a conductive material such as a metal.

A conductive film 23 is formed on the reverse face of the substrate 21. The conductive film 23 is a conductive film in which a conductive material is added to a base material made of a resin material. The resin material is such as an epoxy material, a urethane material, an acrylic material, a silicone material or the like. The conductive material is not limited if the conductive material has conductivity. The conductive material is a low resistance material such as Ag (silver), Cu (copper), Au (gold) or the like.

An eddy current may occur in the conductive film 23 even if the magnetic flux permeates the scale 20, because the conductive film 23 includes the conductive material. It is therefore possible to suppress the influence of the support member 33. Generally, the Young's modulus of the resin material is 1 GPa to 10 GPa which is smaller than the Young's modulus of the Cu-plated film which is 10 GPa to 100 GPa. It is therefore possible to suppress the warp of the substrate 21. Accordingly, it is possible to suppress the warp and inhomogeneous distribution of the eddy current.

The resin material before applying to the substrate 21 is a paste-shaped material. It is possible to apply the resin material to the substrate 21 by a simple process such as a screen printing or a dispenser. It is therefore possible to reduce the cost. Waste liquid such as plating waste solution is not brought about.

It is preferable that the conductive material of the conductive film 23 has magnetic shielding performance which does not permeate the magnetic flux. When the conductive film 23 does not permeate the magnetic flux, the magnetic flux does not reach the support member 33. It is therefore possible to suppress the influence of the support member 33. The conductive material having the magnetic shielding performance is such as permalloy or ferrite.

The resin material such as the epoxy material, the urethane material, the acrylic material, the silicone material or the like has adhesiveness. Therefore, the resin material is used for mounting of IC chips. When the resin material is used, it is not necessary to newly prepare another adhesive agent for bonding the scale 20 and the support member 33. It is therefore possible to perform coating with the resin material and bonding the support member 33 to the scale 20 in a single process.

It is preferable that the conductive film 23 covers the whole of the reverse face of the substrate 21. In this case, it is possible to suppress the leak of the magnetic flux and suppress the influence of the support member 33. Whatever shape the support member 33 has, the support member 33 supports the scale 20 through the conductive film 23. Therefore, the shape of the support member 33 has no influence. For example, even if the position of the scale 20 supported by the support member 33 is changed, the distribution of the eddy current in the support member 33 gets smaller. It is preferable that the conductive film 23 has a thickness so that sufficient amount of the eddy current flows. For example, it is preferable that the thickness d of the conductive film 23 is d=√(2ρ/ωμ) or more from a viewpoint of the skin effect. “ρ” is an electric resistivity. “ω” is an angular frequency. “μ” is an absolute magnetic permeability.

The present invention is not limited to the specifically disclosed embodiments and variations but may include other embodiments and variations without departing from the scope of the present invention.

What is claimed is:

1. A scale comprising:
a substrate;
a scale pattern that has conductivity and is provided on a first main face of the substrate; and
a conductive film that is provided on a second main face of the substrate, a base material of the conductive film being a resin material, a conductive material being added to the base material.

2. The scale as claimed in claim 1, wherein the conductive material of the conductive film has magnetic shielding performance.

3. The scale as claimed in claim 1, further comprising:
a support member configured to support a part of the second main face.

4. The scale as claimed in claim 3, wherein the resin material has adhesiveness between the substrate and the support member.

5. The scale as claimed in claim 1, wherein the conductive film covers a whole of the second main face.
